(19) United States
(12) Patent Application Publication
(10) Pub. No.: US 2025/0217274 A1
(43) Pub. Date: Jul. 3, 2025

(54) METHOD AND APPARATUS WITH REGISTER FILE OPERATOR

(71) Applicant: Samsung Electronics Co., Ltd., Suwon-si (KR)

(72) Inventors: Jangho AN, Suwon-si (KR); Jaehyuk LEE, Suwon-si (KR); Soon-Wan KWON, Suwon-si (KR)

(73) Assignee: Samsung Electronics Co., Ltd., Suwon-si (KR)

(21) Appl. No.: 18/940,221

(22) Filed: Nov. 7, 2024

(30) Foreign Application Priority Data
Dec. 29, 2023 (KR) 10-2023-0195982

(51) Int. Cl. G06F 12/02; G06F 7/544

(52) U.S. Cl. CPC G06F 12/0223; G06F 7/5443

(57) ABSTRACT

A register file operator including a memory cell array, the memory cell array including plural subarrays configured to perform an operation between data stored in memory cells and input data, the plural subarrays which each include two read ports configured to read data as received data and a write port configured to write data as written data, and an operation circuit configured to output one or more of operation results of the memory cell array and pieces of the received data read through the two read ports.

### CROSS-REFERENCE TO RELATED APPLICATIONS

This application claims the benefit under 35 USC § 119 (a) of Korean Patent Application No. 10-2023-0195982, filed on Dec. 29, 2023, in the Korean Intellectual Property Office, the entire disclosure of which is incorporated herein by reference for all purposes.

### BACKGROUND

### 1 Field

The following description relates to a method and apparatus with a register file operator.

### 2. Description of Related Art

A register file is an array of registers of a central processing unit (CPU), which may be a location where the CPU temporarily stores data when retrieving the data from a main memory or cache and processing the retrieved data. The use of a register file may reduce the need to continuously access a memory, which may lead to an increase in energy efficiency and data processing speed. In addition, in-memory computing (IMC) may accelerate a matrix-unit multiply-accumulate (MAC) operation for the learning and inference functions of artificial intelligence (AI).

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, here is provided a register file operator including a memory cell array, the memory cell array including plural subarrays configured to perform an operation between data stored in memory cells and input data, the plural subarrays which each include two read ports configured to read data as received data and a write port configured to write data as written data, and an operation circuit configured to output one or more of operation results of the memory cell array and pieces of the received data read through the two read ports.

The register file operator may be configured to simultaneously, in one clock cycle, perform a read operation on different addresses of the memory cell array and a write operation on a random address of the memory cell array.

The register file operator may be configured to perform the read operation on a rising edge of a clock cycle and perform the write operation on a falling edge of the clock cycle.

The register file operator may be configured to read the pieces of received data from two different addresses of the memory cell array through the two read ports on the rising edge of the clock cycle and write the written data in the memory cell array through the write port on the falling edge of the clock.

The subarrays further may include the memory cells, the memory cells being configured to store the data and including static random access memory (SRAM) cells, a multiplier configured to perform a multiplication operation between the written data stored in the memory cells and the input data, a first switch configured to determine whether to write the written data stored in the memory cells, and a second switch configured to determine whether to read the received data stored in the memory cells.

The operation circuit may include an adder tree configured to sum the operation results of the memory cell array and read first received data among the pieces of received data, an accumulator configured to perform a shift operation and an accumulation operation on the summed results of the adder tree, and a buffer configured to store second received data such that the first received data output through the accumulator among the pieces of received data is output simultaneously with the second received data of the memory cells relayed through a second read bit line.

The register file operator may be configured to simultaneously perform, in different subarrays, a first read operation on the first received data using the adder tree and a second read operation on the second received data using the second read bit line.

Each of the subarrays may include a write word line, a first read word line, and a second read word line, which are word lines in a row direction and a write bit line, a first read bit line, and a second read bit line, which are bit lines in a column direction.

The write word line may be used for access for a write operation for the memory cells and is connected to the write bit line to gate a first switch configured to determine whether to write the written data in the memory cells.

The second read bit line may be used for access for a read operation for the memory cells and is connected to the second read bit line to gate a second switch configured to determine whether to read the data stored in the memory cells.

The register file operator may be configured to determine a write target subarray in which written data is to be written among the subarrays by selecting the write word line of each of the subarrays.

The register file operator may be configured to determine a read target subarray by inputting a second logic value to other first read word lines of other subarrays excluding the read target subarray in which the data is to be read among the subarrays.

The register file operator may be configured to access memory cells of a write target subarray in which written data is to be written among the subarrays by applying a first logic value to the write word line, select a write target memory cell by applying the first logic value to a first write selection line corresponding to the write target memory cell in which the written data is to be written among the memory cells, and write the written data in the write target memory cell by relaying the written data input through the write bit line to the first write selection line through a local write bit line connected to a first switch.

The register file operator may be configured to access memory cells of a read target subarray from which the received data is to be read among the subarrays by applying a first logic value to the second read word line, select a read target memory cell by applying the first logic value to a first read select line corresponding to the read target memory cell in which the received data is to be read among memory cells of the read target subarray, and read the received data stored in the read target memory cell through the second read bit line connected to a read bit line.

The register file operator may be configured to perform a multiplication operation in a multiplier of each of the subarrays by applying the input data to a first read word line of the subarrays and applying a second logic value to all second read word line of the subarrays.

The register file operator may include the subarrays arranged in a plurality of columns, and the register file operator is configured to share a first read bit line, a second read bit line, and a write bit line in a same column of the plurality of columns and a first read word line, a second read word line, and a write word line among the plurality of columns.

The register file operator may be configured to perform an operation of one of a multiply-accumulate (MAC) operation, a vector-matrix multiplication (VMM) operation, and a matrix-matrix multiplication (MMM) operation.

The subarrays may include one of four SRAM memory cells, eight SRAM memory cells, and thirty-two SRAM memory cells.

In a general aspect, here is provided a method including accessing memory cells of a read target subarray from which received data is to be read among subarrays included in a memory cell array of a register file operator, selecting a read target memory cell from which the received data is to be read from among memory cells of the read target subarray, reading the received data stored in the read target memory cell, performing a multiplication operation between the received data and input data in each of the subarrays, and summing results of the multiplication operation and performing and outputting a shift operation and an accumulation operation on the summed results.

The method may include accessing memory cells of a write target subarray in which written data is to be written among the subarrays, selecting a write target memory cell in which the written data is to be written from among the memory cells, and writing the written data in the write target memory cell.

### BRIEF DESCRIPTION OF THE DRAWINGS

FIG. 1 illustrates an example register file operator according to one or more embodiments.

FIG. 2 illustrates an example system on chip (SoC) structure including the register file operator according to one or more embodiments.

FIG. 3 illustrates an example structure and operation of the register file operator according to one or more embodiments.

FIG. 4 illustrates an example structure and operation of a register file operator including 4-bit memory cells according to one or more embodiments.

FIG. 5 illustrates an example memory cell according to one or more embodiments.

FIG. 6A illustrates an example write operation of a register file operator according to one or more embodiments.

FIGS. 6B and 6C illustrate examples of read operations of the register file operator according to one or more embodiments.

FIG. 7 illustrates an example process of performing a multiply-accumulate (MAC) operation between vectors in the register file operator according to one or more embodiments.

FIG. 8 illustrates an example structure and operation of a register file operator including 8-bit memory cells according to one or more embodiments.

FIG. 9 illustrates an example structure and operation of a register file operator including columns of a plurality of memory cells according to one or more embodiments.

FIG. 10 illustrates an example operating method of the register file operator according to one or more embodiments.

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when a component or element is described as being “on”, “connected to,” “coupled to,” or “joined to” another component, element, or layer it may be directly (e.g., in contact with the other component or element) “on”, “connected to,” “coupled to,” or “joined to” the other component, element, or layer or there may reasonably be one or more other components, elements, layers intervening therebetween. When a component or element is described as being “directly on”, “directly connected to,” “directly coupled to,” or “directly joined” to another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

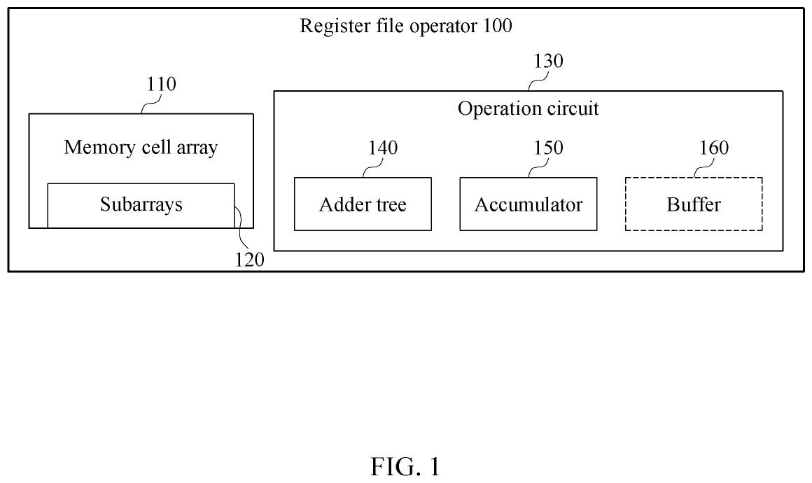

FIG. 1 illustrates an example register file operator according to one or more embodiments. Referring to FIG. 1, in a non-limiting example, a register file operator 100 may include a memory cell array 110 and an operation circuit 130.

The memory cell array 110 may include two read ports and one write port and may include subarrays 120 configured to perform an operation between data stored in memory cells and input data. In an example, the two read ports may correspond respectively to a first read word line RWL1 and a second read word line RWL2. In addition, the write port may correspond to a write word line WWL.

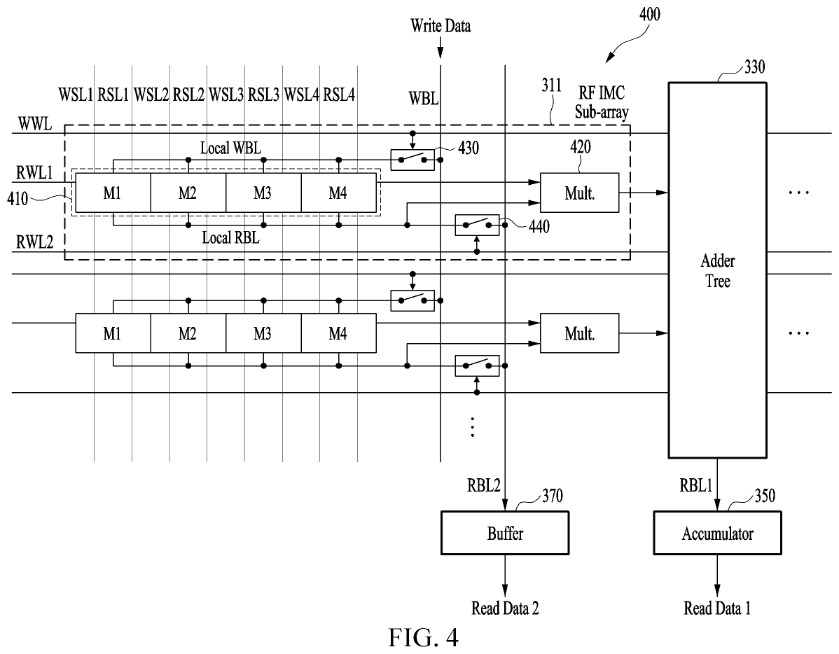

In an example, the subarrays 120 may include memory cells (e.g., memory cells 410 of FIG. 4), an operator (e.g., a multiplier 420 of FIG. 4), and two switches (e.g., a first switch 430 and a second switch 440 of FIG. 4). The memory cells may store data. The data may be, for example, a weight for a multiply-accumulate (MAC) operation or input data. A multiplier may perform a multiplication operation between the data stored in the memory cells and the input data. The two switches may determine whether the memory cells read or write the data. A first switch may determine whether to write the data stored in the memory cells. A second switch may determine whether to read the data stored in the memory cells. The structure and operation of the subarrays 120 are described in greater detail below with reference to FIG. 4.

The operation circuit 130 may output at least one of operation results of the memory cell array 110 and pieces of data read through the two read ports. In an example, the data read through the read ports may be referred to as received data. The operation circuit 130 may include an adder tree 140, an accumulator 150, and a buffer 160. In an example, the buffer 160 may be used selectively (i.e., optionally).

In an example, the adder tree 140 may sum the operation results of the memory cell array 110 and may read first read data among the pieces of read data. The adder tree 140 may relay the summed results to the accumulator 150 through a first read bit line RBL 1.

In an example, the accumulator 150 may perform a shift operation and an accumulation operation on the summed results of the adder tree 140.

In an example, the buffer 160 may store second read data such that the first read data output through the accumulator 150 among the pieces of read data is output simultaneously with the second read data of the memory cells relayed through a second read bit line RBL2.

In an example, the accumulator 150 may relay a first read result of an operation (multiplication) result output from the multiplier, and the buffer 160 may store a second read result relayed to the second read bit line RBL2 of the memory cells through the two switches. The pieces of data (i.e., received data) that are read by the two read ports of the memory cell array 110 may be output simultaneously through the accumulator 150 and the buffer 160.

In an example, the register file operator 100 may simultaneously perform, in different subarrays, a first read operation on the first read data using the adder tree 140 and a second read operation on the second read data using the second read bit line RBL2.

The register file operator 100 may simultaneously perform a read operation on different addresses of the memory cell array 110, which is a register file, in one clock cycle and a write operation on a random address of the memory cell array 110. In an example, the register file may include, based on a 32-bit word system, thirty-two 32-bit registers, and a program counter. Each of the registers may store 32-bit data and may be used to perform simple operations, such as arithmetic or logical operations. In an example, a structure of an in-memory computing (IMC) circuit may be partially altered to be used as a register file.

The register file operator 100 may perform the read operation on a rising edge of a clock and may perform the write operation on a falling edge of the clock.

The register file operator 100 may read the pieces of read data (i.e., received data) from two different addresses of the memory cell array 110 through the two read ports on the rising edge of the clock and may write data in the memory cell array 110 through the write port on the falling edge of the clock. In an example, the data written through the write port may also be referred to as written data.

The register file operator 100 may simultaneously perform a read operation of first data and a write operation of second data in one cycle of the clock.

In an example, the register file operator 100 may perform an operation of at least one of a MAC operation, a vector-matrix multiplication (VMM) operation, and a matrix-matrix multiplication (MMM) operation.

In an example, by partially altering the structure of the IMC circuit to use it as a register file, a function of the register file and a function of the IMC circuit may both be performed.

In an example, the register file operator 100 may perform MAC and/or non-MAC operations in a processor and may reduce an area of the register file and the IMC circuit by the size of the IMC circuit.

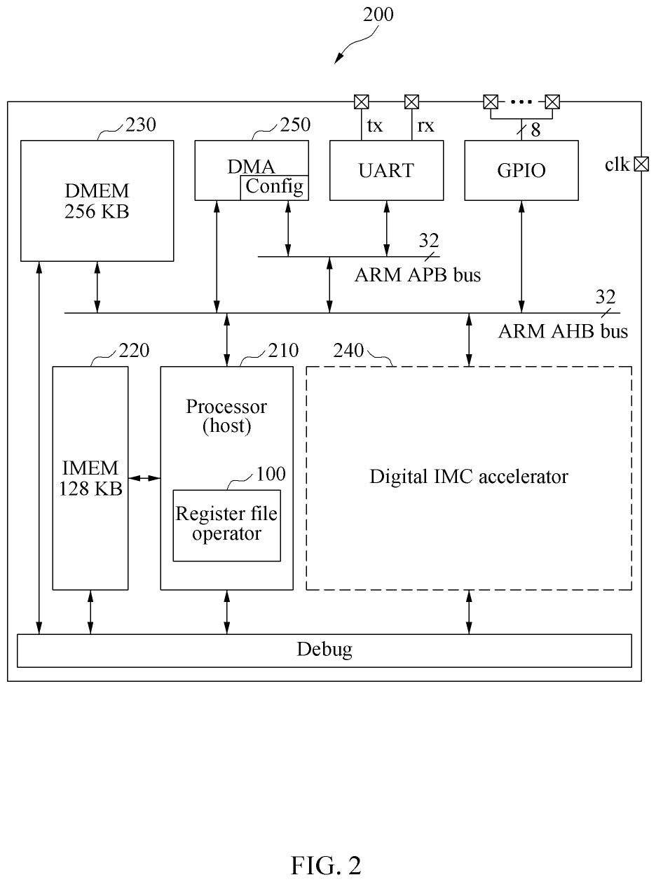

FIG. 2 illustrates an example system on chip (SoC) structure including the register file operator according to one or more embodiments. Referring to FIG. 2, in a non-limiting example, electronic apparatus 200 illustrates the SoC structure including a central processing unit (CPU) 210 and an IMC accelerator 230, in which the CPU 210 includes the register file operator 100.

For an artificial intelligence (AI) operation, various neural network operations may be performed other than a MAC operation, and, generally, a processor, like the CPU 210, may directly process such operations. Accordingly, in an example, the SoC structure for an AI operation may include a processor (or the CPU) 210, memories (e.g., an instruction memory (IMEM) 220 and a data memory (DMEM) 230) for the processor 210, and/or an IMC accelerator 240.

The processor 210, the memories, or the IMEM 220 and the DMEM 230, and/or the IMC accelerator 240 may be connected through a bus. one or more embodiments IMC accelerator 240 may be used selectively (i.e., optionally).

The processor 210 may perform a certain operation per instruction or may control the IMC accelerator 240.

The IMEM 220 may store instructions. The DMEM 230 may store data processed by the processor 210.

In an example, the processor 210 may read the instructions from the IMEM 220 to process (perform) the instructions and, during the processing of the instructions, may generate and transmit a control signal, and/or may perform an operation. The processor 210 may write the generated control signal and/or a result of performing the operation in an internal register file or the DMEM 230. In an example, according to an instruction, the processor 210 may read the data stored in the DMEM 230 and may write it in the register file operator 100.

In an example, the IMC accelerator 240 may perform a MAC operation. The DMEM 230 may store a MAC operation result, and the processor 210 may use the stored MAC operation result when performing a non-MAC operation.

In an example, the use of the IMC accelerator 240 may be highly efficient for an application in which a ratio of a MAC operation is substantially higher than a ratio of another operation (i.e., non-MAC operations). However, the efficiency of the IMC accelerator 240 may decrease for an application in which a ratio of a MAC operation is relatively low compared to another operation.

In an example, the movement of data input/output to/from the IMC accelerator 240 may be performed through direct memory access (DMA) 250. The processor 210 may generate and process a control signal for the IMC accelerator 240 and the DMA 250. However, when the ratio of a MAC operation is relatively lower than the ratio of a non-MAC operation, the time and energy required to control the IMC accelerator 240 may be relatively greater than those required for the operations themselves. As the non-MAC operation increases, pieces of data may not be sequentially processed only by using the IMC accelerator 240, and thus, programmability and versatility may decrease.

In an example, the use of the register file operator 100 for performing an IMC-based MAC operation function and a register file function together, other than basic read and write functions, may prevent the time and energy required to control the IMC accelerator 240 from further increasing compared to those required for the operations themselves in an instruction pipeline of the processor 210.

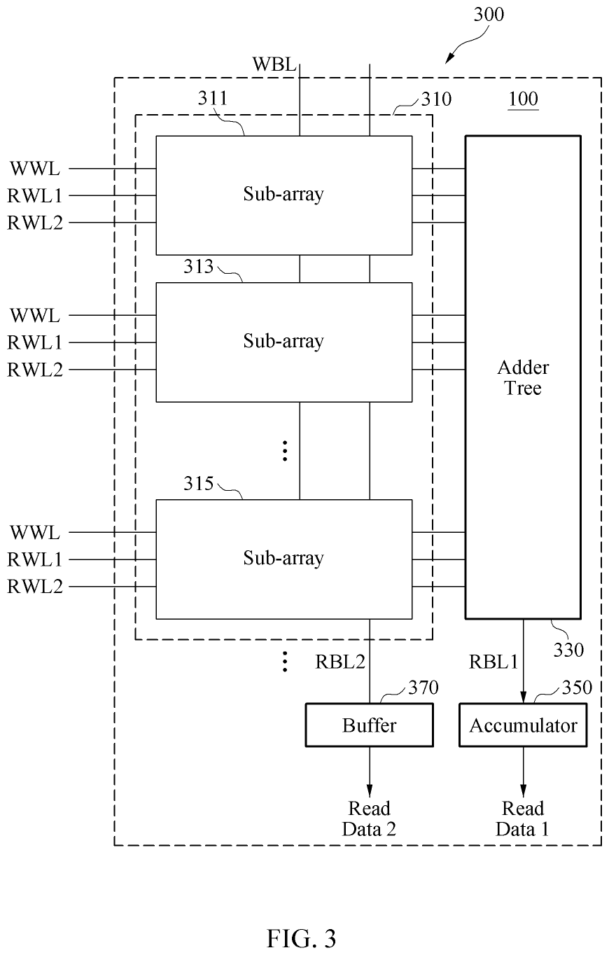

FIG. 3 illustrates an example structure and operation of the register file operator according to one or more embodiments. Referring to FIG. 3, in a non-limiting example, electronic apparatus 300 illustrates the structure and operation of the register file operator 100.

In an example, the register file operator 100 may perform various operations including a MAC operation other than an operation of reading or writing data by registers included in a register file. The registers of the register file operator 100 may include a digital SRAM IMC structure. That is, the register file operator 100 may include SRAM's as memory cells and/or other memory and data structures.

In an example, the register file operator 100 may include an SRAM-based memory cell array 310 and an adder tree 330.

In an example, the SRAM-based memory cell array 310 may include subarrays 311, 313, and 315 including SRAMs (i.e., SRAM memory cells) as memory cells.

In an example, each of the subarrays 311, 313, and 315 may include a write word line WWL, a first read word line RWL1, and a second read word line RWL2, which are word lines in a row direction. In this case, one subarray may include the write word line WWL, the first read word line RWL1, and the second read word line RWL2 as one unit.

In addition, each of the subarrays 311, 313, and 315 may include a write bit line WBL, a first read bit line RBL1, and a second read bit line RBL2, which are bit lines in a column direction. The memory cell array 310 may read data simultaneously from different subarrays by using two different read addresses. In other words, the memory cell array 310 may read pieces (‘pieces of read data’) of data stored in different subarrays through the first read bit line RBL1 and the second read bit line RBL2.

In an example, each of the subarrays 311, 313, and 315 may receive input data through the write bit line WBL. Data stored in each of the memory cells may be output as read data through a local read bit line (local RBL).

In an example, the write word line WWL may be used for access for a write operation for the memory cells. The write word line WWL may be connected to the write bit line WBL to gate a first switch for determining whether to write the written data in the memory cells. In this case, ‘gating a switch’ may be understood as adjusting the switch to be on/off.

In an example, the first read bit line RBL1 may be used for access for a read operation for first read data stored in the adder tree 330.

In an example, the second read bit line RBL2 may be used for access for a read operation for memory cells storing second read data. The second read word line RWL2 may be connected to the second read bit line RBL2 to gate a second switch for determining whether to read the data stored in the memory cells.

In an example, the register file operator 100 may determine a write target subarray in which write data is to be written among the subarrays 311, 313, and 315 by selecting the write word line WWL of each of the subarrays 311, 313, and 315. The register file operator 100 may determine a read target subarray by inputting a second logic value (e.g., ‘0’) to all the first read word line RWL1 of other subarrays excluding the read target subarray in which the data (e.g., read data) is to be read among the subarrays 311, 313, and 315.

In an example, each of the subarrays 311, 313, and 315 may include any one of four SRAM memory cells, eight SRAM memory cells, and thirty-two SRAM memory cells, but examples are not limited thereto.

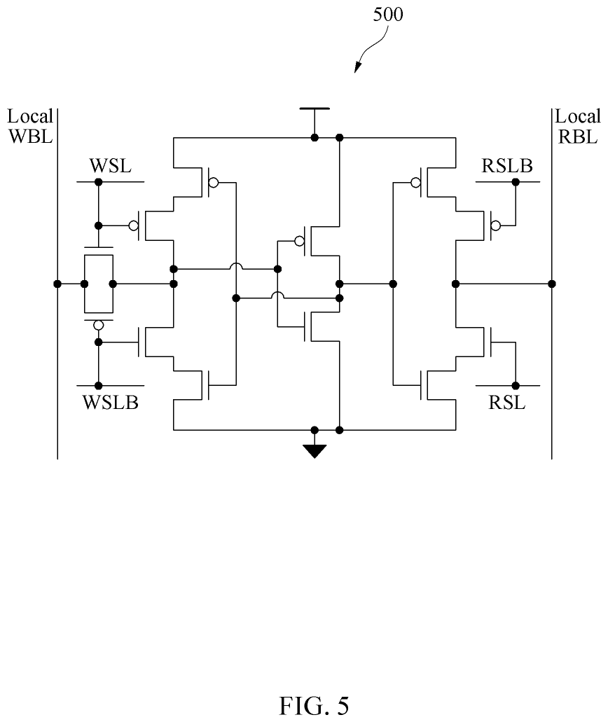

In an example, the subarrays 311, 313, and 315 may include SRAMs including multiple transistors, such as 6-transistor (T) or 12-T, as memory cells as illustrated in greater detail below in FIG. 5. A memory cell may include one or more SRAMs, and n memory cells including SRAMs may store n-bit data.

In an example, each of the subarrays 311, 313, and 315 may include a multiplier (e.g., the multiplier 420 of FIG. 4) for performing a multiplication operation between first data that is input and second data that is stored in the memory cells. An operation result of the multiplier included in each of the subarrays 311, 313, and 315 may be relayed to the adder tree 330. The adder tree 330 may add all operation results received from the multiplier included in each of the subarrays 311, 313, and 315 to output the added results to the accumulator 350 through the first read bit line RBL1.

The register file operator 100 may include two read ports and one write port and may simultaneously perform read and write operations through all the ports.

The process that the register file operator 100 performs a MAC operation is described as follows.

In an example, the register file operator 100 may perform a multiplication operation on the input data received through the write bit line WBL and data (‘read data’) of a memory cell that is output through the local RBL and may perform a MAC operation by summing multiplication operation results in the adder tree 330. In this case, a MAC operation may be performed on the whole memory cell array 310 when all the subarrays 311, 313, and 315 of the memory cell array 310 access the write word line WWL.

In addition, the process that the register file operator 100 performs a read operation is described as follows.

In an example, the register file operator 100 may perform a read operation for two different memory cells. Each memory cell may have two read word lines RWLs for read access. When the read word lines RWLs in each memory cell are the first read word line RWL1 and the second read word line RWL2, respectively, a value of data (‘the first read data’) read by the first read word line RWL1 may be directly applied to the multiplier. The second read word line RWL2 may be used as an on/off value of a switch (e.g., the second switch 440 of FIG. 4) connected to the local RBL. The first read data applied to the multiplier may be read through the adder tree 330.

In an example, when the switch (e.g., the second switch 440) is ‘ON’ by a value of the second read word line RWL2, data (e.g., ‘the second read data’) of memory cells M1, M2, M3, and M4 (e.g., the memory cells 410 of FIG. 4) output to the local RBL may be output to the second read bit line RBL2. Accordingly, a value of the memory cells may be directly read by the second read bit line RBL2.

In an example, when the switch (e.g., the second switch 440) is ‘OFF’ by a value of the second read word line RWL2, the data (e.g., ‘the second read data’) of the memory cells output to the local RBL may be input to the multiplier. In this case, when a value of the first read word line RWL1 is a first logic value (e.g., ‘1’), an operation result of the multiplier may be the same as the value of the memory cells, and the value may be relayed to the adder tree 330. In this case, the register file operator 100 may set, to the first logic value (e.g., ‘1’), a value of the first read word line RWL1 for access to a target subarray (e.g., the subarray 311) to be read, and all values of the first read word line RWL1 for the remaining the subarrays (e.g., the subarray 313 and the subarray 315) may be set to the second logic value (e.g., ‘0’). In this case, all the values of the remaining subarrays 313 and 315, excluding the target subarray 311 to be read, may be the second logic value (e.g., ‘0’) according to a multiplication operation, and the value (e.g., ‘0’) of the remaining subarrays may be output to the first read bit line RBL1. As such, the register file operator 100 may simultaneously read the first read bit line RBL1 and the second read bit line RBL2 by appropriately accessing the first read word line RWL1 and the second read word line RWL2.

The process that the register file operator 100 performs a write operation is described as follows.

Each of the subarrays 311, 313, and 315 may have a write word line WWL for write access in the register file operator 100.

In an example, the register file operator 100 may access the memory cells of the subarrays 311, 313, and 315 through the write word line WWL. In this case, data (‘write data’) to be written in the memory cells may be input through the write bit line WBL. The write word line WWL may be used as an on/off value of a switch (e.g., the first switch 430 of FIG. 4) connected to a local write bit line (local WBL). When a value of the switch (e.g., the first switch 430) is ‘ON’, a value of the write bit line WBL may be written in each of the memory cells through the local WBL.

In an example, the register file operator 100 may perform both a MAC operation and a non-MAC operation by partially altering the structure of an IMC circuit to use it as a register file. In addition, by partially altering the structure of the IMC circuit to use it as a register file, the register file operator 100 may reduce an area by the size of the IMC circuit.

FIG. 4 illustrates an example structure and operation of a register file operator including 4-bit memory cells. Referring to FIG. 4, in a non-limiting example, a register file operator 400 may include the subarray 311 including the 4-bit memory cells (e.g., the memory cells M1, M2, M3, and M4).

In an example, the subarray 311 may include multiple SRAM memory cells 410 (e.g., the memory cells M1, M2, M3, and M4) and an operator (e.g., the multiplier 420) and may perform a multiplication operation. All operation (multiplication) results of each subarray 311 may be added in the adder tree 330 and may be accumulated in the accumulator 350 such that a MAC operation may be performed.

In an example, the subarrays 311 may include the memory cells M1, M2, M3, and M4 410, the operator (e.g., the multiplier 420), and two switches (e.g., the first switch 430 and the second switch 440).

The memory cells M1, M2, M3, and M4 410 may store data. The multiplier 420 may perform a multiplication operation between the data stored in the memory cells M1, M2, M3, and M4 410 and the input data. In an example, the multiplier 420 may be an AND gate, but examples are not limited thereto.

In an example, the first and second switches 430 and 440 may determine whether to read and write the data stored in the memory cells M1, M2, M3, and M4 410. The first switch 430 may determine whether to write the data stored in the memory cells M1, M2, M3, and M4 410. The second switch 440 may determine whether to read the data stored in the memory cells M1, M2, M3, and M4 410.

In an example, each of the subarrays may have a write word line WWL, a first read word line RWL1, and a second read word line RWL2, which are word lines in a row direction, and a write bit line WBL, a first read bit line RBL1, and a second read bit line RBL2, which are bit lines in a column direction.

The write word line WWL may be used for access for a write operation for the memory cells M1, M2, M3, and M4 410, and the second read bit line RBL2 may be used for access for a read operation for the memory cells M1, M2, M3, and M4 410. The write word line WWL may gate the first switch 430 connected to the write bit line WBL. In addition, the second read word line RWL2 may gate the second switch 440 connected to the second read bit line RBL2. The first read word line RWL1 may also be used for a read operation and may be applied as an input to the multiplier 420. The reading through the first read word line RWL1 may be performed through an operation of the multiplier 420.

The write word line WWL may be used for access to the memory cells M1, M2, M3, and M4 410 during a write operation. The write word line WWL may be used to write data (‘write data’) input from the write bit line WBL in the memory cells M1, M2, M3, and M4 410 by gating the first switch 430 connected to the write bit line WBL. In an example, the subarrays may include the write bit line WBL, and the register file operator 400 may determine a subarray in which data is to be written by selecting the write word line WWL of each of the subarrays. In addition, each of the memory cells M1, M2, M3, and M4 410 may include a select line SL to write data by selecting any one of the memory cells M1, M2, M3, and M4 410 in the subarray 311. Each of the memory cells M1, M2, M3, and M4 410 may include a write SL WSL and a read SL RSL.

The method that the register file operator 400 writes data in a first memory cell M1 among the memory cells M1, M2, M3, and M4 410 in the subarray 311 is described as follows.

In an example, the register file operator 400 may apply a first logic value (e.g., ‘1’) to the write word line WWL and may access the memory cells M1, M2, M3, and M4 410 of the target subarray 311 in which data is to be written. The register file operator 400 may apply the first logic value (e.g., ‘1’) to the first write selection line WSL1 and may select the first memory cell M1 from among the memory cells M1, M2, M3, and M4 410. The write data input as the write bit line WBL may be relayed to the first write selection line WSL1 through the local WBL connected to the first switch 430 and may be written in the first memory cell M1.

In an example, when intending to write data in the second memory cell M2 among the memory cells M1, M2, M3, and M4 410, the register file operator 400 may apply the first logic value (e.g., ‘1’) to the second write selection line WSL2, and not to the first write selection line WSL1, and may select the second memory cell M2 from among the memory cells M1, M2, M3, and M4 410. The write data input as the write bit line WBL may be relayed to the second write selection line WSL2 through the local WBL connected to the first switch 430 and may be written in the second memory cell M2.

In an example, the second read word line RWL2 may be used for access to the memory cells M1, M2, M3, and M4 410 for a read operation. The register file operator 400 may gate the second switch 440 connected to the second read bit line RBL2 and may obtain data read from the memory cells M1, M2, M3, and M4 410 through the second read bit line RBL2. In an example, the subarrays may include the second read bit line RBL2, and the register file operator 400 may determine a subarray from which data is to be read by selecting the second read word line RWL2 of each of the subarrays. The register file operator 400 may select any one of the memory cells M1, M2, M3, and M4 410 in a subarray through the select line SL and may read data.

In an example, the register file operator 400 may use the adder tree 330 to read data (e.g., first read, or received, data Data 1) and may read the memory cells M1, M2, M3, and M4 410 through the second read bit line RBL2 to read data (e.g., second read, or received, data Data 2).

The method through which the register file operator 400 reads the data of any one memory cell (e.g., the first memory cell M1) among the memory cells M1, M2, M3, and M4 410 through the second read bit line RBL2 is described as follows.

The register file operator 400 may access a corresponding subarray by applying the first logic value (e.g., ‘1’) to the second read word line RWL2 and may select the first memory cell M1 by applying the first logic value (e.g., ‘1’) to the first read select line RSL1. In this case, the data stored in the first memory cell M1 may be read through the second read bit line RBL2 connected to the local RBL. When intending to read the second memory cell M2, the register file operator 400 may select the second memory cell M2 by applying the first logic value (e.g., ‘1’) to the second read select line RSL2, not the first read select line RSL1, and may read the data stored in the second memory cell M2 may be read through the second read bit line RBL2 in the local RBL. The first read word line RWL1 may be used to perform a read operation, and the data (e.g., ‘read data’) read through the first read word line RWL1 may be directly input to the multiplier 420 to be used for a multiplication operation.

In addition, the method that the register file operator 400 reads the data of any one memory cell (e.g., the first memory cell M1) among the memory cells M1, M2, M3, and M4 410 by using the adder tree 330 is described as follows.

In an example, the register file operator 440 may apply the second logic value (e.g., ‘0’) to the second read word line RWL2 and may turn off the second switch 440 between the second read bit line RBL2 and the local RBL. As the second switch 440 is off, a value of the local RBL may be relayed through the second read bit line RBL2 without being read and may be input to the multiplier 420. In this case, the data input to the multiplier 420 may correspond to data of any one memory cell (e.g., the first memory cell M1) of the memory cells M1, M2, M3, and M4 410, and the register file operator 400 may select any one memory cell (e.g., the first memory cell M1) through the read select line RSL. In this case, the register file operator 400 may apply the first logic value (e.g., ‘1’) to the first read word line RWL1 such that the first logic value (e.g., ‘1’) may be input to the multiplier 420. The first logic value (e.g., ‘1’) of the first read word line RWL1 and the data of the selected memory cell (e.g., the first memory cell M1) may be input to the multiplier 420 and a multiplication operation may be performed. An operation result of the multiplier 420 may be added to a value of another multiplier (or a multiplier corresponding to another memory array) through the adder tree 330 and may be relayed to the first read bit line RBL1. In this case, when an operation result of other subarrays is not the second logic value (e.g., ‘0’), an error may be caused in a value of a subarray to be read. Therefore, the register file operator 400 may perform a read operation through the adder tree 330 only on one subarray (e.g., the subarray to be read). In this case, the second logic value (e.g., ‘0’) may be input to all the first read word line WSL1 of the other subarrays excluding the subarray to be read.

The register file operator 400 may simultaneously perform, in different subarrays, a first read operation using the adder tree 330 and a second read operation using the second read bit line RBL2, as described above.

In an example, the data (e.g., the ‘read data’) read through the read operations may be output simultaneously to the first read bit line RBL1 and the second read bit line RBL2. In this case, the first read bit line RBL1 may be connected to the accumulator 350 for shift-and-accumulation operations which may be part of a MAC operation. A delay may occur during a process of the first read data being output through the accumulator 350 and then passing through the accumulator 350. The buffer 370 may be an element that may resolve the delay which may occur in the process of the first read data being output through the accumulator 350. The buffer 370 may be connected to the second read bit line RBL2. The buffer 370 may store the second read data relayed through the second read bit line RBL2. The buffer 370 may store the second read data until the first read data is output from the accumulator 350 and may output the second read data in synchronization with the first read data. In other words, the first read data relayed through the first read bit line RBL1 and the second read data relayed through the second read bit line RBL2 may be output simultaneously through the accumulator 350 and the buffer 370, respectively.

The process that the register file operator 400 performs a MAC operation by using the memory cell array 311 and an operation circuit is described as follows.

First, in an example, data (e.g., a weight) to be used for the MAC operation may be stored in the memory cells M1, M2, M3, and M4 410. The register file operator 400 may apply another value (e.g., input data) required for the MAC operation to the first read word line RWL1 of all subarrays and may apply the second logic value (e.g., ‘0’) to all the second read word line RWL2. In this case, a multiplication operation may be performed in the multiplier 420 of all the subarrays 311, and a result of the multiplication operation may be relayed to the adder tree 330. Output values of all the subarrays 311 may be added in the adder tree 330 such that the MAC operation may be performed.

When performing the MAC operation, an operation may be performed in a data storage unit (e.g., a 1-bit unit) of the memory cells M1, M2, M3, and M4 410 in each of the subarrays 311. Accordingly, when performing the MAC operation for n-bit memory cells, the register file operator 400 may vary the read select line RSL of the memory cells by each cycle during n cycles to select each of the memory cells. In an example, the register file operator 400 may be a 4-bit operator that includes 4 memory cells, such as the memory cells M1, M2, M3, and M4 410, as illustrated in FIG. 4, and then the register file operator 400 may perform operations in the order of the memory cells M1, M2, M3, and M4 during 4 cycles. In this case, the data (e.g., the ‘input data’) input to the first read word line RWL1 may also be sequentially input in a bit-serial bit unit. An adding operation of 4-bit operation results may be performed through the adder tree 330 during 4 cycles, and the multiplier 350 may perform a shift operation and accumulation operation on an adding operation result such that a final MAC operation result may be output.

FIG. 5 illustrates an example structure of a memory cell according to one or more embodiments. Referring to FIG. 5, in a non-limiting example, SRAM memory cell 500 may include a 12-T transistor.

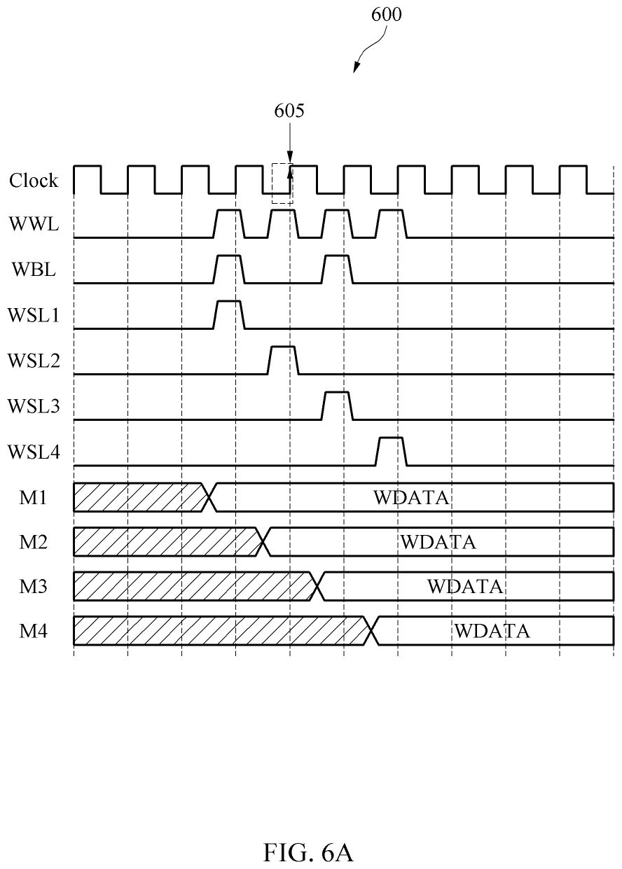

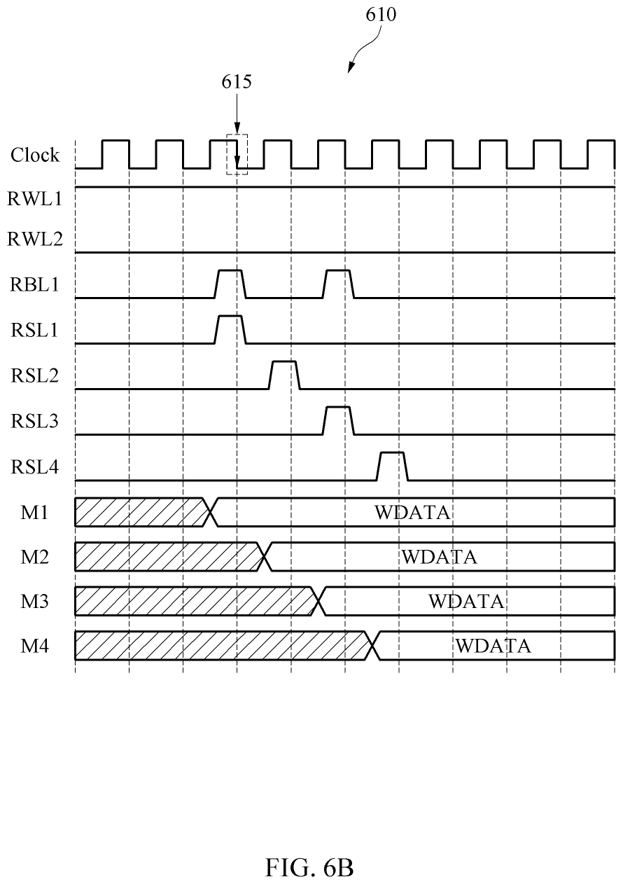

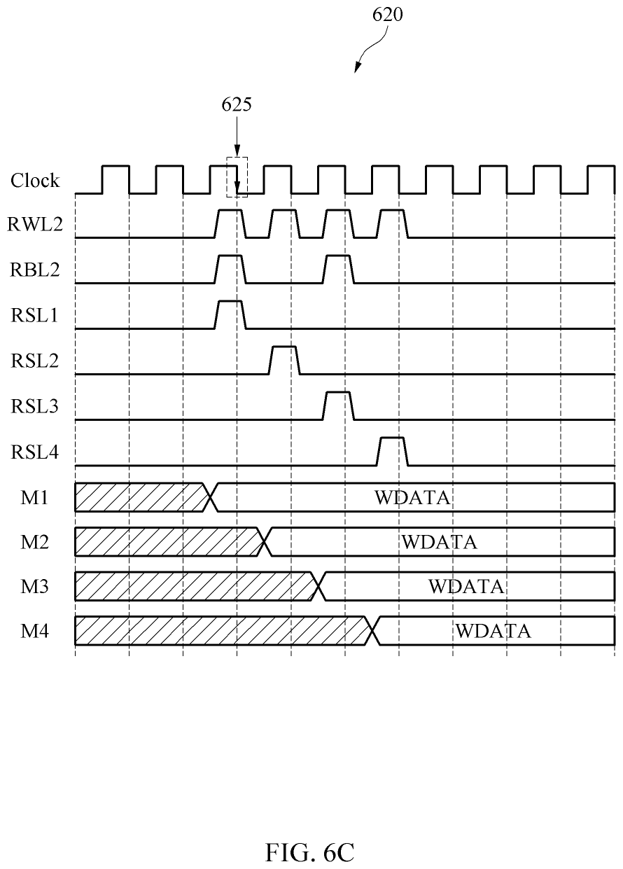

FIG. 6A illustrates an example write operation of a register file operator according to one or more embodiments.

Referring to FIG. 6A, in a non-limiting example, timing diagram 600 illustrates the register file operator as it performs a write operation through a write word line WWL.

FIGS. 6B and 6C illustrate examples of read operations of the register file operator according to one or more embodiments.

Referring to FIG. 6B, in a non-limiting example, timing diagram 610 illustrates the register file operator as it performs a first read operation through a first read bit line RBL1. Referring to FIG. 6C, in a non-limiting example, timing diagram 620 illustrates the register file operator as it performs a second read operation through a second read bit line RBL2.

In an example, to simultaneously perform a read operation and a write operation in one clock cycle, the register file operator may perform a write operation according to a rising edge 605 of one clock as illustrated in timing diagram 600 of FIG. 6A and may perform a read operation according to falling edges 615 and 625 of the clock as illustrated in timing diagram 610 of FIG. 6B and timing diagram 620 of FIG. 6C. These read and write operations may enable the register file operator to operate as a register file having one write port and two read ports.

The register file operator may simultaneously perform a read operation on different addresses of a memory cell array and a write operation on a random address of the memory cell array in one clock cycle.

In an example, referring back to FIG. 6A, the register file operator may apply ‘1’ to the write word line WWL on the rising edge 605 of a clock, as illustrated in timing diagram 600, to perform the write operation, and may access memory cells. At the same time, the register file operator may set a write select line WSLx corresponding to a write target memory cell to ‘1’ to select a memory cell (e.g., the ‘write target memory cell’) in which data is to be written. The register file operator may input write data to a write bit line WBL. The write data may be written in the write target memory cell for which the write select line WSLx was set to ‘1’.

Referring back to FIG. 6B, the register file operator may apply ‘1’ to a first read word line RWL1 on the falling edge 615 of the clock as illustrated in timing diagram 610 to perform the read operation through the first read bit line RBL1, may apply ‘1’ to a read select line RSLx to select a memory cell to be read, and may apply ‘0’ to a second read word line RWL2. In this case, the second read word line RWL2 may include a switch (e.g., the second switch 440), and data of the memory cells may be input to a multiplier (e.g., the multiplier 420 of FIG. 4) with ‘0’ applied to the second read word line RWL2. A multiplication result obtained by the multiplier may be output to the first read bit line RBL1 through an adder tree.

Referring back to FIG. 6C, the register file operator may apply ‘1’ to the second read word line RWL2 on the falling edge 625 of the clock, as illustrated in timing diagram 620, to perform the read operation on the memory cells through the second read bit line RBL2 and may read data (e.g., ‘second read data’) stored in a selected memory cell by applying ‘1’ to the read select line RSLx.

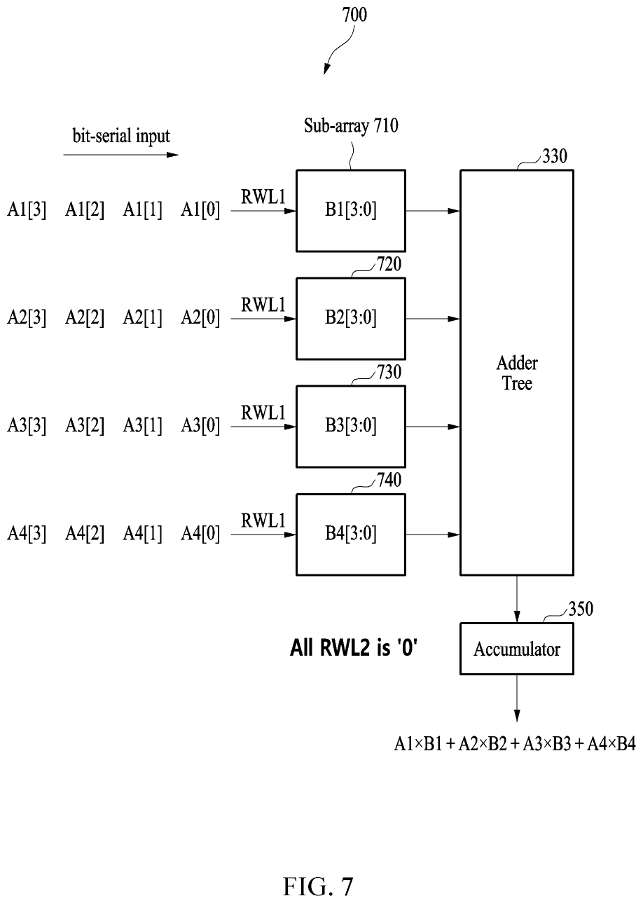

FIG. 7 illustrates an example process of performing a MAC operation between vectors in the register file operator according to one or more embodiments. Referring to FIG. 7, in a non-limiting example, process 700 illustrates the register file operator as it performs a MAC operation between a vector A and a vector B.

In an example, the register file operator may perform a MAC operation in a vector unit.

In an example, the register file operator may perform a vector MAC operation of (1×n)×(n×1) by inputting a value to a first read word line RWL1 of each of subarrays 710, 720, 730, and 740, which all share the same first read bit line RBL1.

An example of the register file operator performing a MAC operation on the vector A and the vector B including 4-bit values is described as follows.

In an example where four memory cells are expressed by 4 bits, a value of Bj [3:0] may be written in each of the subarrays 710, 720, 730, and 740. In this case, the register file operator may input an Ai value to each of the subarrays 710, 720, 730, and 740 by using the first read word line RWL1. In this case, an input of an Ai[3:0] value expressed by four bits may be performed in a bit unit. The register file operator may perform an operation in an order of Ai[0]×Bj [3:0], Ai[1]×Bj [3:0], Ai[2]×Bj [3:0], and Ai[3]×Bj [3:0] during four clock cycles. The register file operator may sequentially select each of the memory cells by selecting a read select line RSL in an order of RSL0, RSL1, RSL2, and RSL3.

In addition, to perform an operation in a vector unit, the register file operator may perform an operation in all the subarrays 710, 720, 730, and 740 and may perform an addition operation by bits in the adder tree 330. A result value (e.g., an addition operation result) output through the adder tree 330 may be output as a final MAC operation as shown in Equation 1 below after going through a shift operation and an accumulation operation in the accumulator 350.

$$\begin{matrix}\begin{matrix}A = [ \begin{matrix}A 1 & A 2 & A 3 & A 4\end{matrix} ] , & B = [ \begin{matrix}B 1 & B 2 & B 3 & B 4\end{matrix} ] ,\end{matrix} \\ AB = [ A 1 B 1 + A 2 B 2 + A 3 B 3 + A 4 B 4 ]\end{matrix} \qquad Equation 1$$

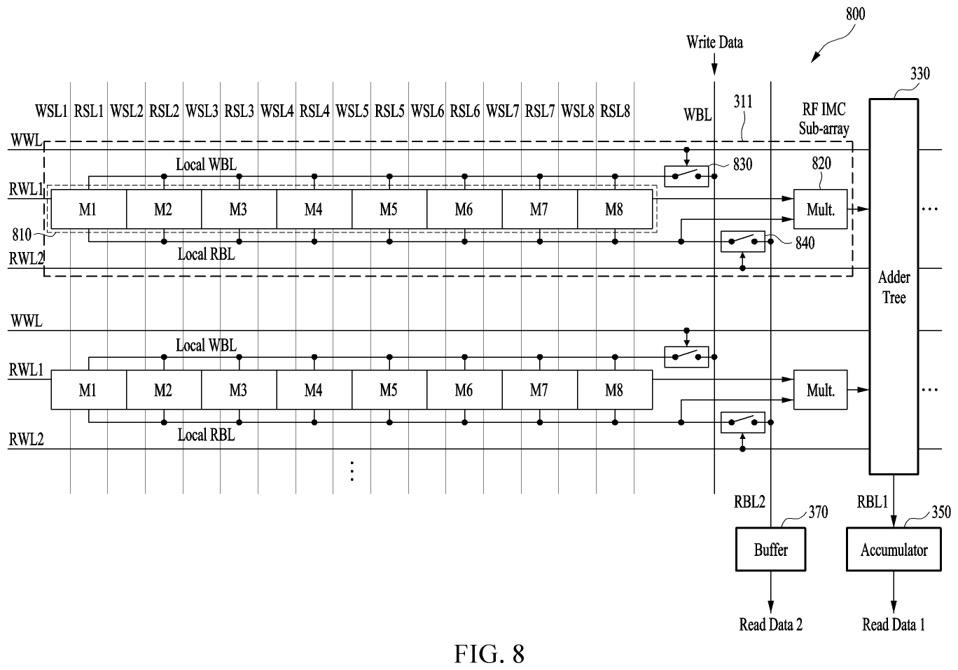

FIG. 8 illustrates an example structure and operation of a register file operator including 8-bit memory cells according to one or more embodiments. Referring to FIG. 8, in a non-limiting example, a register file operator 800 may include 8-bit memory cells M1, M2, M3, M4, M5, M6, M7, and M8 810.

Unlike the register file operator 400 including the 4-bit memory cells as illustrated above in FIG. 4, in an example, four read select lines (e.g., RSL5, RSL6, RSL 7, and RLS8) and four write select lines (e.g., WSL5, WSL6, WSL7, and WSL8) for selecting each of eight memory cells M1, M2, M3, M4, M5, M6, M7, and M8 810 may be further added to the register file operator 800.

The operations of the multiplier 420, the first switch 430, and the second switch 440 were described above in greater detail with respect to FIG. 4 may apply to the operations of a multiplier 820, a first switch 830, and a second switch 840 in the register file operator 800.

In an example, the register file operator 800 may simultaneously perform a read operation and a write operation in an 8-bit unit such that the degree of integration may increase, and operational efficiency may also increase through a MAC operation in an 8-bit unit.

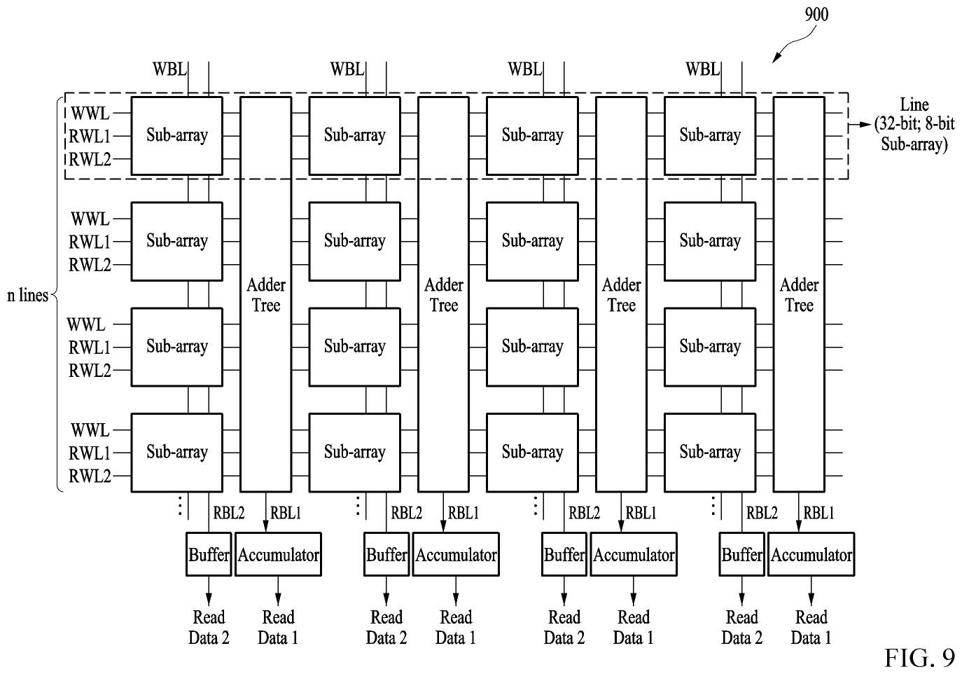

FIG. 9 illustrates an example structure and operation of a register file operator including columns of a plurality of memory cells according to one or more embodiments. Referring to FIG. 9, in a non-limiting example, a register file operator 900 may include memory cell arrays having a 32-bit size by columns.

In an example, the register file operator 900 may have a structure in which a register file operator including multiple subarrays (e.g., four subarrays) is expanded into multiple columns.

The register file operator 900 may include four subarrays including 8-bit memory cells arranged as a plurality of columns. In this case, each column may include an adder tree and four subarrays arranged a row direction. The register file operator 900 may share a first read bit line RBL1, a second read bit line RBL2, and a write bit line WBL in each column and a first write word line RWL1, a second write word line RWL2, and a write word line WWL among the plurality of columns.

In an example, the structure of the register file operator 900 illustrated in FIG. 9 may increase the size of data read or written during one cycle, and thus may increase a line size of a register file. In an example, a 4-bit register file operator having 8 columns may configure a generally used register file of a 32-bit line size. In addition, in a structure in which memory cells are read and written in a subarray unit, the register file operator 900 may be used as a vector register file. When using a line after dividing it into vector elements based on the columns of the register file operator 900, the register file operator 900 may also be used as a vector register file having elements as many as the number of the columns.

In addition, the register file operator 900 having the structure illustrated in FIG. 9 may perform a VMM operation and/or an MMM operation.

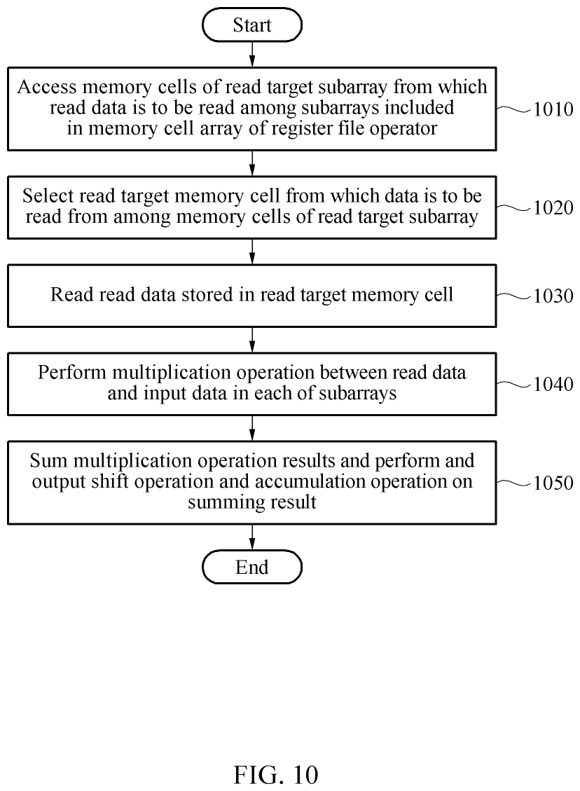

The register file operator 900, may simultaneously perform a large amount of MAC operations at once by writing all matrix data in the memory cells of the subarrays and applying input data for performing a MAC operation to the first read word line RWL1. Accordingly, in an example, the register file operation 900 may improve the efficiency of its operations. FIG. 10 illustrates an example operating method of the register file operator according to one or more embodiments. Operations to be described with reference to FIG. 10 may be performed sequentially but may not necessarily be performed sequentially. For example, the order of the operations may change and at least two of the operations may be performed in parallel or one operation may be performed separately.

Referring to FIG. 10, in a non-limiting example, the register file operator (e.g., register file operator 800) may output an operation result through operations 1010 to 1050.

In an example, in operation 1010, the register file operator may access memory cells of a read target subarray from which read data is to be read among subarrays included in a memory cell array of the register file operator. The register file operator may apply a first logic value (e.g., ‘1’) to a second read word line RWL2 of the subarrays of the memory cell array and may access the memory cells of the read target subarray from which the read data is to be read among the subarrays.

In an example, in operation 1020, the register file operator may select a read target memory cell from which data is to be read from among the memory cells of the read target subarray accessed in operation 1010. The register file operator may apply the first logic value to a first read select line RSL1 of the memory cell array and may select the read target memory cell.

In an example, in operation 1030, the register file operator may read the read data stored in the read target memory cell selected in operation 1020. The register file operator may read the read data stored in the read target memory cell through a second read bit line RBL2 connected to a local RBL.

In an example, in operation 1040, the register file operator may perform a multiplication operation between the read data that was read through operation 1030 and input data in each of the subarrays. The register file operator may perform the multiplication operation between the read data and the input data by applying the input data to a first read word line RWL1 of the subarrays and applying a second logic value to the second read word line RWL2.

In an example, in operation 1050, the register file operator may sum multiplication operation results and may perform and output a shift operation and an accumulation operation on the summed results.

In addition, the register file operator may access memory cells of a write target subarray in which write data is to be written among the subarrays. The register file operator may apply the first logic value to a write word line WWL of the memory cell array and may access the memory cells of the write target subarray.

The register file operator may select a write target memory cell in which the write data is to be written from among the memory cells. The register file operator may apply the first logic value to a first write select line WSL1 of the memory cell array and may select the write target memory cell.

The register file operator may write the write data in the write target memory cell. The register file operator may write the write data in the write target memory cell by relaying the write data input through the write bit line WBL to the first write selection line WSL1 through a local WBL connected to a first switch.

The electronic apparatuses, operators, register file operator 100, memory cell array 110, subarrays 120, operation circuit 130, adder tree 140, accumulator 150, buffer 160, electronic apparatus 200, CPU 210, IMC accelerator 230, IMEM 220, IMC accelerator, DMA 250, electronic apparatus 300, SRAM-based memory cell array 310, adder tree 330, register file operator 400, SRAM memory cell 500, register file operator 800, and register file operator 900 described herein and disclosed herein described with respect to FIGS. 1-10 are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-10 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A register file operator, comprising:
a memory cell array, the memory cell array comprising:
plural subarrays configured to perform an operation between data stored in memory cells and input data, the plural subarrays each comprising:
two read ports configured to read data as received data; and
a write port configured to write data as written data; and
an operation circuit configured to output one or more of operation results of the memory cell array and pieces of the received data read through the two read ports.

2. The register file operator of claim 1, wherein the register file operator is configured to simultaneously, in one clock cycle, perform a read operation on different addresses of the memory cell array and a write operation on a random address of the memory cell array.

3. The register file operator of claim 2, wherein the register file operator is further configured to:
perform the read operation on a rising edge of a clock cycle; and
perform the write operation on a falling edge of the clock cycle.

4. The register file operator of claim 3, wherein the register file operator is further configured to:
read the pieces of received data from two different addresses of the memory cell array through the two read ports on the rising edge of the clock cycle, and
write the written data in the memory cell array through the write port on the falling edge of the clock.

5. The register file operator of claim 1, wherein the subarrays further comprise:
the memory cells, the memory cells being configured to store the data and comprising static random access memory (SRAM) cells;
a multiplier configured to perform a multiplication operation between the written data stored in the memory cells and the input data;
a first switch configured to determine whether to write the written data stored in the memory cells; and
a second switch configured to determine whether to read the received data stored in the memory cells.

6. The register file operator of claim 1, wherein the operation circuit comprises:
an adder tree configured to sum the operation results of the memory cell array and read first received data among the pieces of received data;
an accumulator configured to perform a shift operation and an accumulation operation on the summed results of the adder tree; and
a buffer configured to store second received data such that the first received data output through the accumulator among the pieces of received data is output simultaneously with the second received data of the memory cells relayed through a second read bit line.

7. The register file operator of claim 6, wherein the register file operator is further configured to simultaneously perform, in different subarrays, a first read operation on the first received data using the adder tree and a second read operation on the second received data using the second read bit line.

8. The register file operator of claim 1, wherein each of the subarrays comprises:
a write word line, a first read word line, and a second read word line, which are word lines in a row direction; and
a write bit line, a first read bit line, and a second read bit line, which are bit lines in a column direction.

9. The register file operator of claim 8, wherein the write word line is used for access for a write operation for the memory cells and is connected to the write bit line to gate a first switch configured to determine whether to write the written data in the memory cells.

10. The register file operator of claim 8, wherein the second read bit line is used for access for a read operation for the memory cells and is connected to the second read bit line to gate a second switch configured to determine whether to read the data stored in the memory cells.

11. The register file operator of claim 8, wherein the register file operator is further configured to determine a write target subarray in which written data is to be written among the subarrays by selecting the write word line of each of the subarrays.

12. The register file operator of claim 8, wherein the register file operator is further configured to determine a read target subarray by inputting a second logic value to other first read word lines of other subarrays excluding the read target subarray in which the data is to be read among the subarrays.

13. The register file operator of claim 8, wherein the register file operator is further configured to:
access memory cells of a write target subarray in which written data is to be written among the subarrays by applying a first logic value to the write word line,
select a write target memory cell by applying the first logic value to a first write selection line corresponding to the write target memory cell in which the written data is to be written among the memory cells, and
write the written data in the write target memory cell by relaying the written data input through the write bit line to the first write selection line through a local write bit line connected to a first switch.

14. The register file operator of claim 8, wherein the register file operator is further configured to:
access memory cells of a read target subarray from which the received data is to be read among the subarrays by applying a first logic value to the second read word line,
select a read target memory cell by applying the first logic value to a first read select line corresponding to the read target memory cell in which the received data is to be read among memory cells of the read target subarray, and
read the received data stored in the read target memory cell through the second read bit line connected to a read bit line.

15. The register file operator of claim 1, wherein the register file operator is configured to perform a multiplication operation in a multiplier of each of the subarrays by applying the input data to a first read word line of the subarrays and applying a second logic value to all second read word line of the subarrays.

16. The register file operator of claim 1, wherein the register file operator comprises the subarrays arranged in a plurality of columns, and
wherein the register file operator is configured to share a first read bit line, a second read bit line, and a write bit line in a same column of the plurality of columns and a first read word line, a second read word line, and a write word line among the plurality of columns.

17. The register file operator of claim 1, wherein the register file operator is configured to perform an operation of one of a multiply-accumulate (MAC) operation, a vector-matrix multiplication (VMM) operation, and a matrix-matrix multiplication (MMM) operation.

18. The register file operator of claim 1, wherein the subarrays comprise one of four SRAM memory cells, eight SRAM memory cells, and thirty-two SRAM memory cells.

19. A method, the method comprising:
accessing memory cells of a read target subarray from which received data is to be read among subarrays comprised in a memory cell array of a register file operator;
selecting a read target memory cell from which the received data is to be read from among memory cells of the read target subarray;
reading the received data stored in the read target memory cell;
performing a multiplication operation between the received data and input data in each of the subarrays; and
summing results of the multiplication operation and performing and outputting a shift operation and an accumulation operation on the summed results.

20. The method of claim 19, further comprising:
accessing memory cells of a write target subarray in which written data is to be written among the subarrays;
selecting a write target memory cell in which the written data is to be written from among the memory cells; and
writing the written data in the write target memory cell.
